(19) United States
(12) Patent Application Publication
(10) Pub. No.: US 2015/0367261 A1
(43) Pub. Date: Dec. 24, 2015

(54) FILTERING DEVICE FOR OIL DRILLING MUD

(71) Applicant: GEOLOG S.r.l., Milano (IT)

(72) Inventor: Antonio CALLERI, Milano (IT)

(21) Appl. No.: 14/742,659

(22) Filed: Jun. 17, 2015

(30) Foreign Application Priority Data
Jun. 20, 2014 (IT) MI2014A001126

(51) Int. Cl. B01D 33/11; B01D 33/067

(52) U.S. Cl. CPC B01D 33/11; B01D 33/067

(57) ABSTRACT

Filtering device for separation of solid debris from oil drilling mud. Filtering device has at least one non-planar filtering surface provided with a longitudinal axis and a plurality of openings for the passage of drilling mud; and a means for cleaning said filtering surface in the form of a rotating shaft coaxial with the filtering surface and a plurality of rotating blades suitable for rotating inside said passage ports, said blades rotating together with said rotating shaft.

### CROSS-REFERENCE TO RELATED APPLICATION

This application claims the benefit of Italian patent application no. MI2014A001126 filed on Jun. 20, 2014 with the Italian Patent and Trademark Office in the name of GEOLOG Srl. The earliest priority date claimed is Jun. 20, 2014.

### FEDERALLY SPONSORED RESEARCH

None

### SEQUENCE LISTING OR PROGRAM

None

### BACKGROUND

The present invention relates to a filtering device for oil drilling mud, this filtering being aimed at the separation of solid debris from a fluid component of said mud. The outstanding feature of the filtering device of the present invention is that of being a “self-cleaning” device. This device, in fact, is provided with its own means for cleaning the filtering surface, i.e. the surface through which mud passes so that the mud is separated from the debris. The purpose of these cleaning means is that of preventing the formation of debris encrustations on the passage openings of said surface which obstruct passage of the drilling mud.

The state of the art, to which the present invention relates, is that of exploration of subsoil's geothermal and oil resources. More particularly, the present invention is part of the sector commonly known as “mud logging” which comprises all those activities of geological surveillance and monitoring that allow information to be obtained both on the nature of the rocky layer drilled and on the features of the possible oil resources of the subsoil. Exploration of the subsoil for the abovementioned purposes takes place by means of well drilling and the consequent analysis both of the drilling debris and the gaseous and liquid elements found in the so-called “drilling muds” brought to the surface.

Drilling muds are fluids that are made to circulate inside the hole during drilling and have several functions, including: support of the drilled hole, lubrication and cooling of the drill during well drilling, conveying rock debris to the surface produced by the mechanical impact of the chisel passing through the rocky layer and of the fluids contained therein. Once it has risen to the surface, the drilling mud and what is contained therein, enter piping known as “flow line,” at the end of which the solid debris are separated from the fluid component which is fed again into the starting tank by means of recirculation piping. During transit in the flow line, part of the mud has to be extracted in order to analyse the volatile components thereof. For this purpose, a pump is used which, by means of a special suction pipe, aspirates the fluid component of the mud and feeds it into a degasser which performs the function of extraction and dilution in air of the gas contained in the drilling mud. The extracted gas is then subjected to chromatographic analysis to identify and quantify its various volatile components.

In order to avoid malfunctioning of the pump, it is necessary for the aspirated drilling mud to be as far as possible free from solid debris. It is necessary therefore to separate this debris from the mud by means of appropriate filtering devices.

The filtering devices of the prior art are constituted, essentially, by a filtering surface provided with passage openings of such dimensions as to allow the mud, but not the debris, to pass through. The filtering surfaces of the prior art can be both planar and non-planar and, in particular, in this latter case, are usually cylindrical in shape. The devices of the prior art provide for the use of systems for cleaning of the filtering surface that performs the removal of the debris encrustations on the passage openings.

In the devices of the prior art, when the filtering surface is planar, the cleaning of the encrustations which are inevitably formed on the passage openings is carried out, usually, by means of knives which, actuated mechanically, act directly in contact with the filtering surface. In the case of cylindrical filtering surfaces, the cleaning of the debris encrustations is performed by blades which rotate externally and around the filtering surface or by cleaning surfaces, i.e. by perforated surfaces, coaxial and external to the filtering surfaces which, by rotating around the filtering surfaces, remove the encrustations thereof.

The cleaning systems of the prior art, although providing for a reduction in encrustation formation, are not able to completely prevent these encrustations from forming and therefore often do not guarantee adequate filtering. The object of the present invention is to provide a filtering device for oil drilling mud with high filtering efficiency by preventing encrustations of debris from forming on the filtering surface and, therefore, avoiding the occurrence of consequent blocking of the passage openings.

Another disadvantage of the cleaning systems of the prior art consists of the occurrence of blockage in the passage openings by particles derived from the breaking-up of the debris caused by the cleaning means themselves. The occurrence of this eventuality makes the filtering device unusable. This occurs, in particular, when knives are used for cleaning planar filtering surfaces.

A second object of the present invention is to provide a filtering device with means for cleaning the filtering surface which do not cause blockage in the passage openings of solid particles.

Finally, a further disadvantage of the filtering devices of the prior art and, in particular, in the case of devices with planar filtering surfaces and where the cleaning means are constituted by metal knives, is that abrasion of the filtering surface may occur because of the passage of the knives. This, in turn, reduces the efficiency and duration of the filtering device itself.

A further object of the present invention, therefore, is that of providing a filtering device provided with means for cleaning the filtering surface which do not cause abrasions on the filtering surface itself.

These objects are achieved by a new means for cleaning the filtering surfaces and a new configuration of the whole constituted by these cleaning means and by these filtering surfaces.

### SUMMARY

The present invention relates to a filtering device constituted by at least one non-planar filtering surface, preferably cylindrical, provided with openings for the passage of mud arranged, preferably, parallel one to the other, and by means for cleaning said at least one filtering surface, constituted by a plurality of blades rotating inside the passage openings.

These blades have a planar extension and are provided with a central hole in which a rotating shaft is inserted which can be moved by any motor of the prior art. This rotating shaft is arranged coaxially with said at least one filtering surface, said filtering surface being preferably cylindrical and, when it is rotated, the blades, consequently, rotate together therewith. The rotary movement of the blades inside the passage openings avoids entrapment of drilling debris inside these openings and consequently prevents the formation of encrustations.

These and further features of the present invention will be made clearer by reading the following detailed description, relating to some preferred embodiments of the present invention to be considered by way of a non-limiting example of the more general concepts claimed.

### DRAWINGS

The following description refers to the accompanying drawings, in which:

FIG. 1 is a perspective view of a filtering device according to the present invention;

FIG. 2 is a perspective view of a detail of a filtering device according to the present invention relating only to the filtering surface;

FIG. 3a is a perspective view of a detail of a filtering device according to the present invention relating to a rotating blade;

FIG. 3b is a perspective view of a detail of a filtering device according to the present invention relating to a spacer element;

FIG. 4a is a perspective view of a detail of the present invention relating to the closure plate;

FIG. 4b is a perspective view of a whole constituted by a detail of the present invention relating to the closure plate and by a spacer element of elongated shape;

FIG. 5 is a perspective view of the assembly constituted by a filtering device according to the present invention and by a pipe for the suction of the drilling mud.

### DETAILED DESCRIPTION OF THE PREFERRED EMBODIMENT

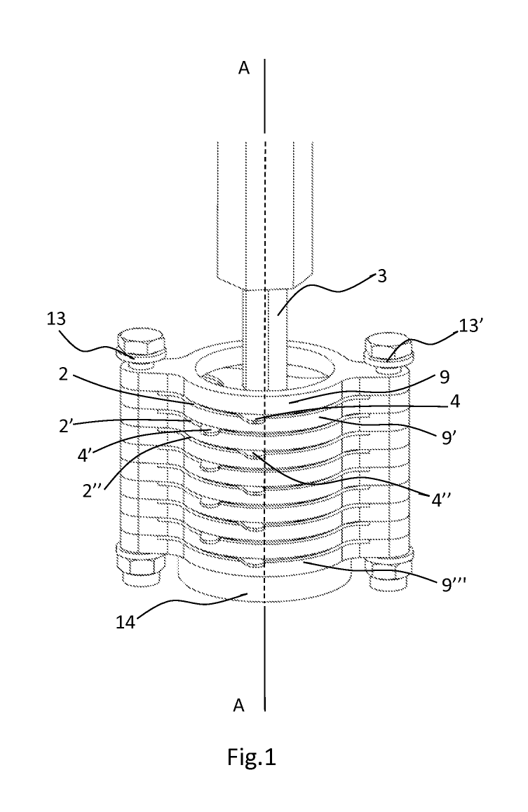

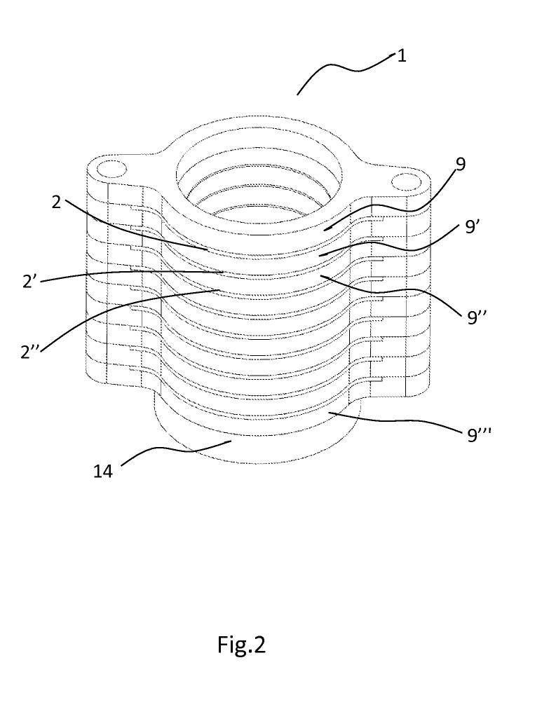

Referring to FIGS. 1 and 2, the device of the present invention comprises a filtering surface of cylindrical shape (1) provided with a plurality of passage openings (2, 2′, 2″) arranged parallel one to the other. Coaxially with this filtering surface (1), i.e. at the axis A of this surface (1), a rotating shaft (3) is positioned, having a polygonal profile. More particularly, in the embodiment shown in FIGS. 1 and 2, the rotating shaft (3) has the shape of a prism with hexagonal base. For the sake of simplicity only three passage openings are denoted here with reference numerals (2, 2′, 2″). As can be seen from the drawings, the passage ports of the embodiment described here, are higher in number and more particularly, there are nine.

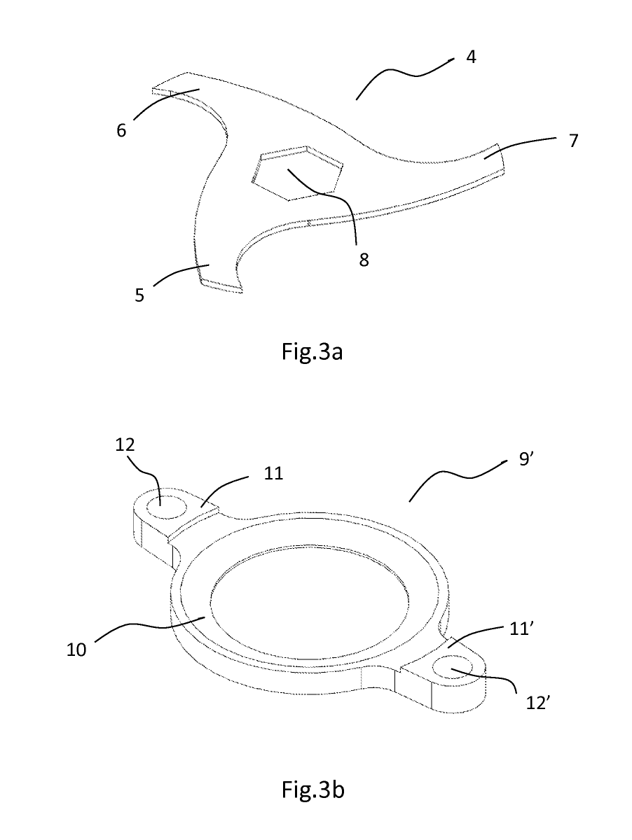

Referring to FIGS. 1, 3a and 3b, the device of the present invention comprises a plurality of rotating blades (4, 4′, 4″) suitable for rotating inside said passage openings (2, 2′, 2″). The planes of rotation of said blades (4, 4′, 4″) are parallel one to the other. Said rotating blades (4, 4′, 4″) are star-shaped and have three tips (5, 6, 7) and are provided with a central hole (8) suitable for accommodating said rotating shaft (3). Said central hole (8) has a polygonal profile shape equal to that of the profile of the rotating shaft (3) so as to allow the fitting of said rotating shaft (3) in said hole (8). The profile of said central hole (8), in the embodiment shown in the drawings, will be, therefore, hexagonal like the rotating shaft (3). As a consequence of the hexagonal shape of the profile, the tips (5, 6, 7) of each rotating blade (4) are staggered through an angle equal to the ratio between the round angle and the number of section polygon sides of the rotating shaft (3). Since, in the present embodiment, the rotating shaft (3) has the shape of a prism with hexagonal base, the tips of each blade (4) will be staggered through 60° with respect to the tips of the adjacent rotating blade (4′). Moreover the blades are arranged in such a way that the tips (5, 6, 7) of each blade (4) are positioned, at least partially, inside each passage opening (2). Thanks to the fitting of said rotating shaft (3) in said hole (8), said blades (4, 4′, 4″) rotate together with said rotating shaft (3).

For the sake of simplicity only three blades are denoted here with reference numerals (4, 4′, 4″). As can be seen from the drawings, the rotating blades of the embodiment described here are higher in number and more particularly, there are nine. The rotating blades (4, 4′, 4″) are distanced one from the other with spacer elements (9′, 9″). Each of these spacer elements (9′, 9″) comprises a central portion (10) shaped like a circular crown centred on the rotating shaft (3) and two peripheral portions (11, 11′) also circular in shape. The peripheral portions are provided with two holes (12, 12′) for the assembly of the spacer elements (9′, 9″) on two support elements (13, 13′). For the sake of simplicity, only two spacer elements (9′) and (9″) are denoted here with reference numerals, said spacer element (9′) being suitable for distancing the blade (4) from the blade (4′) and said spacer element (9″) being suitable for distancing the blade (4′) from the blade (4″). As can be seen from the drawings, the spacer elements of the embodiment described here are higher in number and more particularly, there are eight. Above the first blade (4) there is a further element (9) which, although not being suitable for distancing two blades one from the other, since above it there is no blade, is identical to the other spacer elements (9′) and (9″). Also below the last blade there is a further element (9″) which, although not being suitable for distancing two blades one from the other, is identical to the other spacer elements (9′) and (9″).

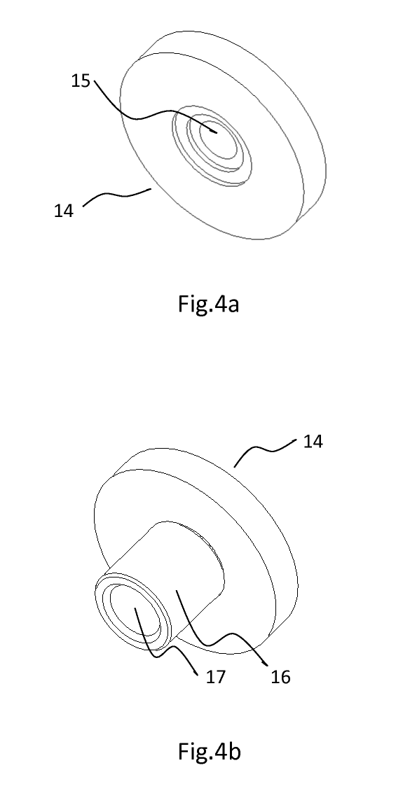

Referring to FIGS. 1, 4a and 4b the filtering device of the present invention comprises, moreover, a closure plate (14) provided with a hole (15) which has such a profile as to function as guide for the rotating shaft (3). Said hole (15) can also serve for the assembly of a further spacer element (16) of elongated shape, suitable for distancing the device from the base of the flow line and/or for protecting it against impact.

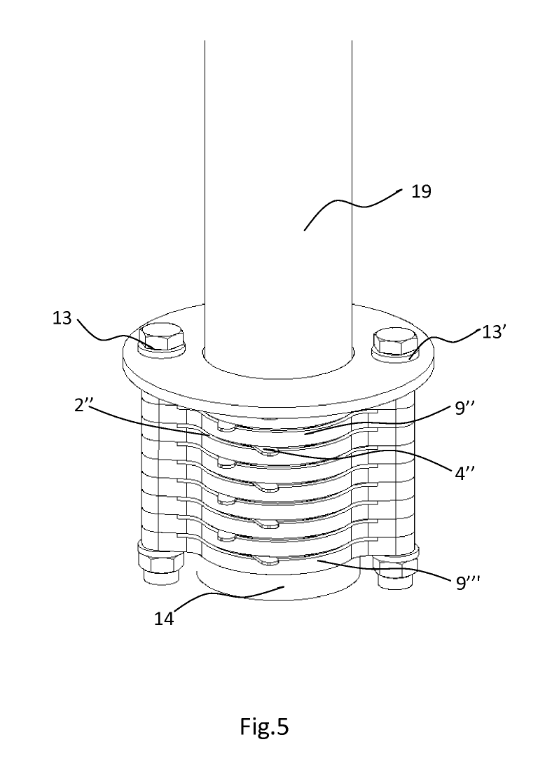

Referring to FIGS. 1 and 5, the device of the present invention can be mounted on a pipe (17) for aspirating the drilling mud, said suction pipe (17) being coaxial with the rotating shaft (3). The function of the suction pipe (17) is that of aspirating the drilling mud during passage in the flow line. The functioning of the device will therefore be the following: during transit in the flow line, the mud is taken in the suction pipe (17) by a pump (not shown in the drawings); before entering the pipe (17), the mud passes through the filtering surface (1) of the device according to the present invention, and the passage openings (2, 2′, 2″) allow only for the passage of the fluid component of the mud, thus preventing solid debris of dimensions greater than the openings from entering the suction pipe (17). During passage of the mud through the filtering surface (1) the drive shaft (3), operated by a motor of the prior art, rotates and the blades (4, 4′, 4″) rotate together with said shaft (3) as a consequence. The tips (5, 6, 7) of said blades (4, 4′, 4″), which are positioned at least partially inside the passage openings (2, 2′, 2″), thanks to their rotation, prevent formation of encrustations.

The continuous rotation of the blades, due to their particular configuration and to their positioning inside the openings for the passage of mud, together with all the other features of the invention described above, mean that encrustations are not formed, there is no abrasion of the filtering surface and there is no risk of the particles jamming derived from the breaking-up of the debris by the blades.

The objects are therefore achieved and in this way a filtering device is provided with a greater filtering efficiency than that of the devices present in the prior art due to elimination of the phenomenon of blocking the passage openings caused by the encrustations.

What is claimed is:

1. A filtering device for the separation of solid debris from oil drilling mud comprising at least one non-planar filtering surface provided with a longitudinal axis A, said filtering surface being provided with a plurality of passage openings for said oil drilling mud, and said passage openings being suitable for preventing the passage of the solid debris; and means for the cleaning of said filtering surface, wherein said means for the cleaning of said filtering surface comprise:
at least one rotating shaft, coaxial with said at least one filtering surface;
a motor for supplying said at least one rotating shaft;
a plurality of rotating blades suitable for rotating inside said passage openings, said blades rotatable with said rotating shaft.

2. The Filtering device according to claim 1, wherein said filtering surface is cylindrical in shape.

3. The Filtering device according to claim 1, wherein said rotating shaft is prismatic in shape.

4. The Filtering device according to claim 1, wherein said motor for supplying said rotating shaft is a motor of the prior art.

5. The Filtering device according to claim 1, wherein each of said rotating blades is star-shaped and is provided with a central hole of prismatic shape equal to that of said rotating shaft, said central hole being suitable for accommodating said rotating shaft in its interior.

6. The Filtering device according to claim 1, wherein each of said rotating blades is star-shaped and has a plurality of tips, said tips being positioned at least partially inside said passage openings.

7. The Filtering device according to claim 1, wherein the tips of each rotating blade are staggered with respect to the tips of the blade adjacent to said blade through an angle equal to the ratio between the round angle and the number of the sides of the section polygon of the rotating shaft (3).

8. The Filtering device according to claim 1, wherein said rotating shaft is a prism with hexagonal base.

9. The Filtering device according to claim 1, wherein each of said rotating blades is star-shaped and has three tips, said tips being positioned at least partially inside said passage openings.

10. The Filtering device according to claim 1, wherein said blades are distanced one from the other with spacer elements, each one of said spacer elements being suitable for forming with the successive spacer a passage opening.

11. The Filtering device according to claim 1, wherein each of said spacer elements comprises a central portion shaped like a circular crown centred on said rotating shaft and two peripheral portions for the assembly of said spacer elements on said support elements.

12. The Filtering device according to claim 1, wherein said filtering device comprises moreover a closure plate, said closure plate being provided with a hole suitable for accommodating said rotating shaft.

13. The Filtering device according to claim 1, wherein said hole of said closure plate is suitable for accommodating a spacer element of elongated shape, said spacer element being suitable for distancing said filtering device from the base of the line of flow and protecting the instrument against impact.
